(19) United States
(12) Patent Application Publication
(10) Pub. No.: US 2007/0063022 A1
(43) Pub. Date: Mar. 22, 2007

(54) Settlement system using electronic money and recording medium for electronic money information

(75) Inventors: Junichi Yamagishi, Chuo-ku (JP); Sakae Ayabe, Isehara-shi (JP)

Correspondence Address: JORDAN AND HAMBURG LLP, 122 EAST 42ND STREET, SUITE 4000, NEW YORK, NY, 10168, US

(73) Assignee: Nihon Unica Corporation, Chuo-ku (JP)

(21) Appl. No.: 11/451,283

(22) Filed: Jun. 12, 2006

(30) Foreign Application Priority Data
Jun. 13, 2005 (JP) 2005-172882

(51) Int. Cl. G06K 5/00

(52) U.S. Cl. 235/380

(57) ABSTRACT

A settlement system using electronic money for accessible objects includes a recording medium for electronic money information and a controller. The recording medium has an electronic money memory storing the electronic money information and an accumulative information memory storing accumulative information for granting a privilege. The accumulative information is accumulated according to spending the electronic money. The controller converts the accumulative information into the privilege on the basis of a set requirement.

### BACKGROUND OF THE INVENTION

1. Field of the Invention

The present invention relates to a settlement system using electronic money and recording medium for electronic money information such as a card-like medium.

2. Description of Related Art

A settlement system employs a card-like medium such as a prepaid card or credit card.

In a system employing a prepaid card, the prepaid card holds a set amount of monetary data, to make settlement by spending the monetary data. After consuming the whole amount of monetary data, the prepaid card cannot be use repeatedly to be discarded. In a system employing a credit card, the credit card is used to make settlement by paying later through a bank draft, for example. The credit card, however, involves a risk of spending too much money. It has also a problem in security.

On the other hand, there is a settlement system employing a noncontact IC card that stores electronic money information to make settlement by spending electric money. The system has a reader/writer to wirelessly read, write, and rewrite the electronic money information. When making settlement for goods and services by the noncontact IC card, the reader/writer subtracts a charge for goods and services from the electronic money stored in the noncontact IC card, to rewrite the electronic money information stored in the noncontact IC card. The noncontact IC card which stores the electronic money is hereinafter referred to as the “electronic money card.”

The electronic money card can solve the problems of the prepaid card and credit card, i.e., the electronic money card can be used repeatedly and securely.

An example of such a settlement system is disclosed in Japanese Unexamined Patent Application Publication No. 2005-107734. The settlement system is applied to an amusement arcade. According to the settlement system of the related art, a user makes an initial deposit to take an electronic money card at an entrance or the like. The user deposits electronic money into the electronic money card through a money input machine, and plays games with the electronic money in the electronic money card.

After consuming the whole amount of the electronic money in the electronic money card, the electronic money card is made redundant unless the user deposits electronic money into the electronic money card again. Therefore, the user returns the electronic money card to refund the initial deposit. Accordingly, it is difficult to lead users to actively come to the amusement arcade again, so that it is also difficult to provide services suitable for the users.

### SUMMARY OF THE INVENTION

An object of the present invention is to provide an electronic settlement system capable of leading users to actively come to a premise again and providing services suitable for the users.

In order to accomplish the object, an aspect of the present invention provides a settlement system using electronic money includes a recording medium for electronic money information. The recording medium has an electronic money memory storing electronic money information, an accumulative information memory storing accumulative information for granting a privilege. The accumulative information is accumulated according to spending the electronic money. The system also includes a controller converting the accumulative information into the privilege according to a set requirement.

Therefore, the system can lead each of users to continuously hold the recording medium storing the accumulative information for granting the privilege. This can lead the users to actively come to a premise again.

Accordingly, the system can provide services suitable for the users by converting the accumulative information into the privilege.

### BRIEF DESCRIPTION OF THE DRAWINGS

FIG. 1 is a block diagram showing an amusement arcade to which a settlement system using electronic money according to a first embodiment of the present invention is applied;

FIG. 2 is a block diagram showing a relationship among an electronic money card, a game machine, a management part, a deposit/refund machine of the settlement system using electronic money of the first embodiment;

FIGS. 3 to 7 are flow charts each showing a process according to the first embodiment of the present invention; and

FIG. 8 is a flow chart showing a process according to a second embodiment of the present invention.

### DETAILED DESCRIPTION OF EMBODIMENTS

A settlement system using electronic money according to embodiments of the present invention will be explained. Each embodiment realizes to lead users to actively come to a premise again and provide services suitable for users by providing an accumulative information memory storing accumulative information for granting a privilege.

A constitution of the settlement system using electronic money will be explained.

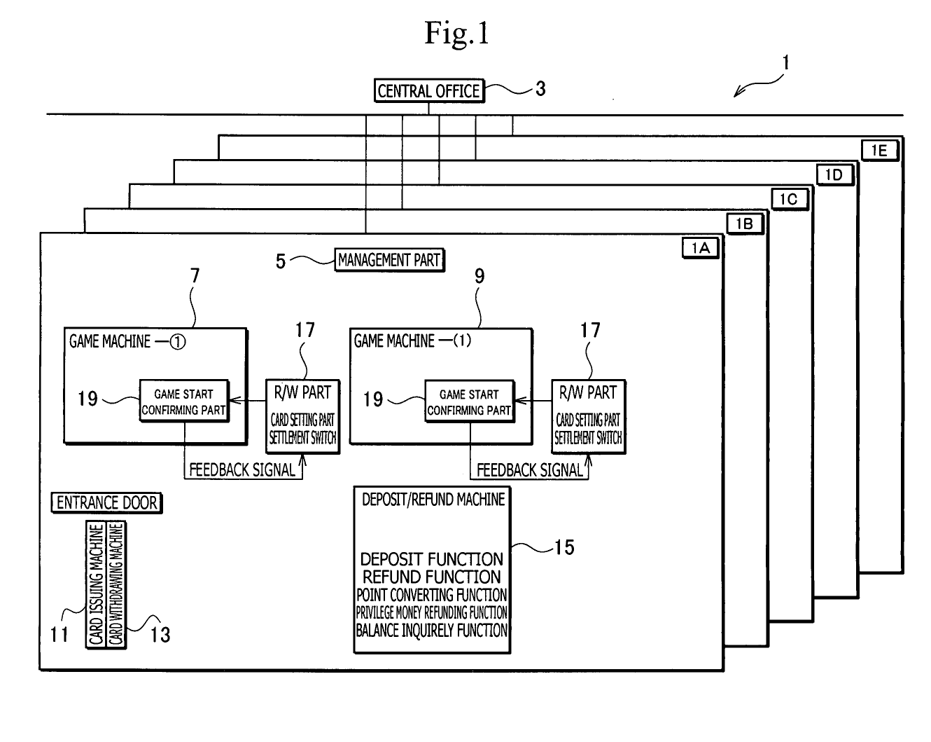

FIG. 1 is a block diagram showing an amusement arcade to which the settlement system using electronic money according to a first embodiment of the present invention is applied.

As shown in FIG. 1, the settlement system using electronic money is located in each of plural amusement arcades 1 (1A, 1B, 1C, 1D, and 1E . . . ) each corresponding to premise. All the amusement arcades 1 are connected to a central office 3 that inclusively manages the amusement arcades 1 via a communication network such as Internet. According to the first embodiment, each amusement arcade 1 has the same structure, and therefore one amusement arcade 1 (1A) will be explained.

The amusement arcade 1 has a management part 5. The management part 5 includes a computer, a read/write (R/W) part, a database, and a master CAU, and is constituted so as to receive sales information and the like in the amusement arcade 1. The management part 5 is connected to the central office 3 via the communication network, so that the central office 3 accesses the management part 5 to manage the sales information and the like of the amusement arcade 1. In addition, the amusement arcade 1 has a plurality of game machines 7 and 9 . . . , a card issuing machine 11, a card withdrawing machine 13, and a deposit/refund machine 15.

The game machines 7 and 9 . . . comprise the same kind or different kinds of machines. Each game machine, corresponding to accessible object, includes a read/write (R/W) part 17 for electronic money cards each serving as a recording medium for electronic money information, a game start confirming part 19, and a slave CAU. The read/write part 17 generates a read/write field to read and write electronic money and available points (point 2) based on electronic money information and available point information stored in an electronic money card. The read/write part 17 subtracts an amount of a charge for a game at the game machine from the read electronic money or read available points. When a user drops from the game machine, the read/write part 17 rewrites the electronic money or available point stored in the electronic money card by the balance. The game start confirming part 19 sends a feedback signal to the read/write part 17 when each game of the game machine is actually started. In response to the feedback signal, the read/write part 17 starts accounting for the game. The read/write part 17 includes a card setting part and settlement switch.

The card issuing machine 11 and the card withdrawing machine 13 are located at, for example, an entrance door. The card issuing machine 11 issues a blank electronic money card for a user in response to input of money as an initial deposit by, for example, inserting cash, a cash card, a credit card thereinto. The card withdrawing machine 13 is used for withdrawing a consumed electronic money card in which the whole amount of electronic money is consumed from a user to refund the money as the initial deposit to the user when the user leaves from the amusement arcade 1.

The deposit/refund machine 15 includes a housing, slots for deposit, refund arranged on the housing, a read/write part arranged on the housing, a display arranged on the housing, a controller installed in the housing, and the like. The deposit/refund machine 15 produces a deposit function, a refund function, a point converting function, a privilege money refunding function, a balance inquiry function, and the like through the controller and the read/write part. With the deposit function, the deposit/refund machine 15 deposits electronic money corresponding to an amount of input money into the electronic money card 21 by storing electronic money information in response to input of money of a user. With the refund function, if electronic money stored in the electronic money card remains, the deposit/refund machine 15 clears a balance of the electronic money stored in the electronic money card and refunds money corresponding to the balance to a user. With the balance inquiry function, the deposit/refund machine 15 outputs a balance of electronic money stored in the electronic money card to the display or the like to enable a user to confirm the balance. The point converting function and the privilege money refunding function will be explained later. The deposit/refund machine 15 is connected to the management part 5 via a wired or wireless local area network, to send the input money information to the management part 5.

Accordingly, a user who wants to play with the game machines 7 and 9 . . . inputs money as an initial deposit into the card issuing machine 11 to take a blank electronic money card at the entrance door first. Next, the user inputs money into the deposit/refund machine 15 to deposit electronic money corresponding to an amount of the input money into the electronic money card by storing electronic money information.

The user brings the electronic money card into the read/write field of the read/write part 17 of any one of the game machines 7 and 9 . . . , to make the read/write part 17 read electronic money or available points stored in the electronic money card. After the reading, the user starts a game at the game machine by operating a start button or the like. At the same time, the game starting part 19 determines whether or not a game of the game machine is started. If the game is started actually, the game starting part 19 determines to start the game and sends the feedback signal to the read/write part 17. In response to the feedback signal, the read/write part 17 subtracts an amount of a charge for the started game from the electronic money or available points read from the electronic money card to make settlement. In this way, the game machine makes settlement for each game by spending electronic money or available points.

The total amount of spent electronic money and available points as sales information is sent to the management part 5 from each game machine 7 (9 . . . ) via the wireless transmission. The central office 3 can access the management part 5 of each amusement arcade 1 to conduct inclusive management of all the amusement arcades 1.

When the user drops from the game machine, the read/write part 17 rewrites the electronic money or the available points stored in the electronic money card by the electronic money information or available point information corresponding to a balance after the subtraction. Therefore, the settlement at the game machine can be completed. After the completion, the user can take the electronic money card to change a game machine.

When the user leaves from the amusement arcade 1 and a balance of the electronic money stored in the electronic money card becomes zero, the user makes the card withdrawing machine 13 withdraw the consumed electronic money card to take a refund of the money as the initial deposit.

On the other hand, the first embodiment can make each user continuously holed and bring back the electronic money card to lead users to actively come to the amusement arcade 1 again, even if the balance of the electronic money stored in the electronic money card becomes zero.

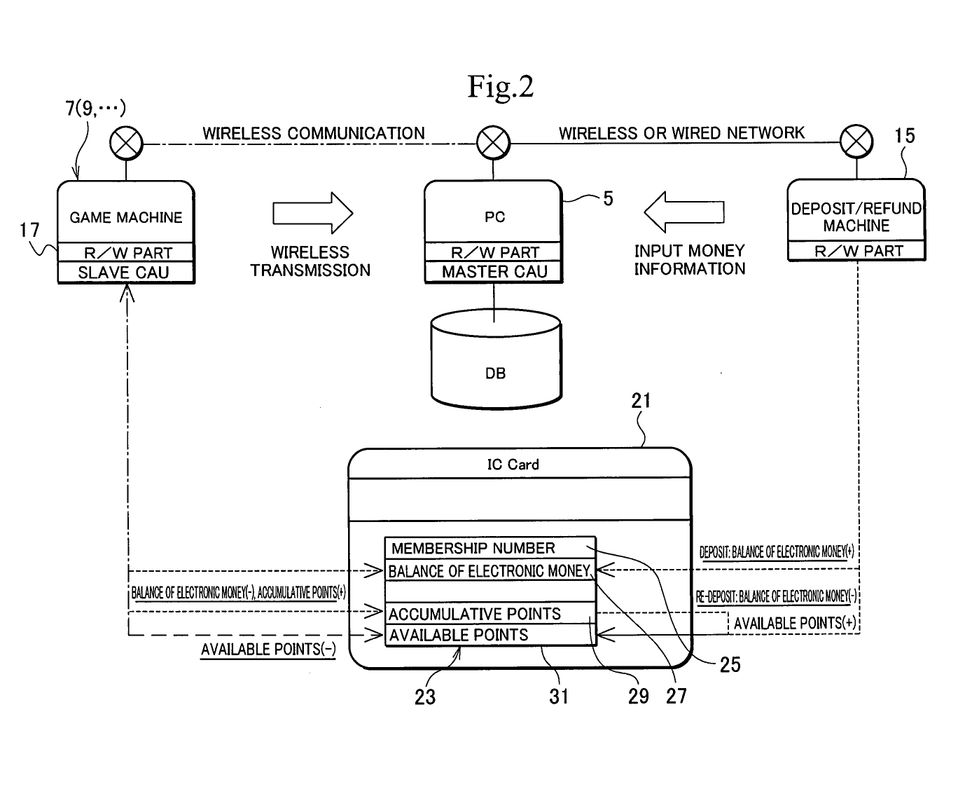

FIG. 2 is a block diagram showing a relationship among the electronic money card 21, the game machine 7 (9 . . . ), the management part 5, the deposit/refund machine 15 of the settlement system using electronic money of the first embodiment.

As shown in FIG. 2, the electronic money card 21 is constituted by, for example, an IC card including a wirelessly communication part and an IC module such as an IC chip.

The IC module has a memory 23 includes a membership number memory 25, an electronic money memory 27, an accumulative point memory 29 serving as an accumulative information memory, a point memory 31 serving as a privilege memory.

The membership number memory 25 stores a membership number information regarding a membership number of a user who brings the electronic money card 21 with. The electronic money memory 27 stores the electronic money information in a readable format. The accumulative point memory 29 stores accumulative point information regarding accumulative points which are accumulated according to spending the electronic money in a readable format. The point memory 31 stores available point information regarding available points in a readable format.

According to the first embodiment, the accumulative points (point 1) corresponding to accumulative information are selectively converted into the available points or privilege money as the privilege according to a set requirement. The user can conduct the conversion at the deposit/refund machine 15. The deposit/refund machine 15 may rewrite the available points based on the available point information stored in the point memory 31 to add the converted available points with the point converting function. The deposit/refund machine 15 may refund money to users with the privilege money refunding function.

According to the first embodiment, the set requirement allows to convert the accumulative points when the accumulative points exceed a predetermined threshold. Instead, other requirements may be adopted.

The accumulative points are accumulated at a predetermined rate against a charge for a game. According to the first embodiment, the accumulative points are obtained by multiplying a charge for a game by a predetermined coefficient. Instead, the accumulative points may be the same value as the charge for a game.

The predetermined rates of the game machines 7 and 9 . . . are set to be different from each other. For example, the predetermined rates of popular game machines may be relatively low, and those of unpopular game machines may be relatively high. Alternatively, the predetermined rates of all the game machines may be set to be the same.

Operation of the settlement system using electronic money will be explained.

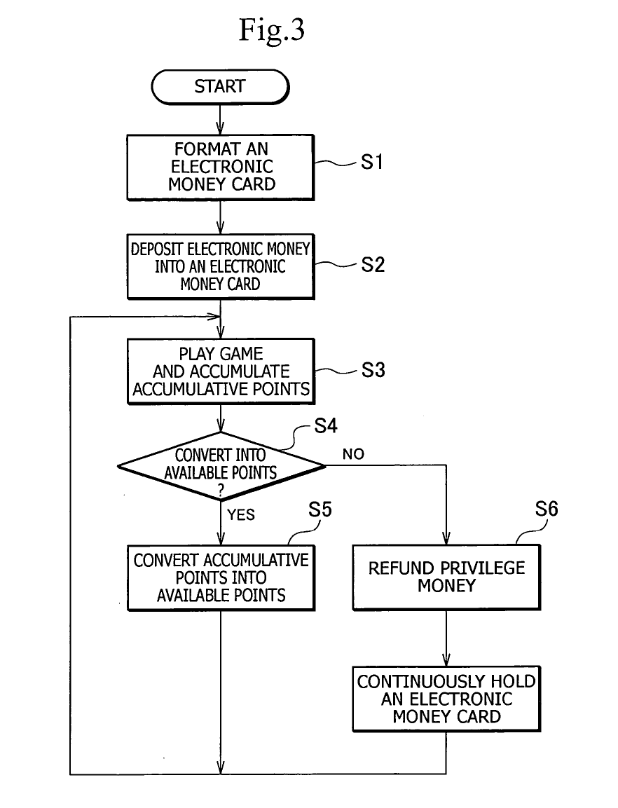

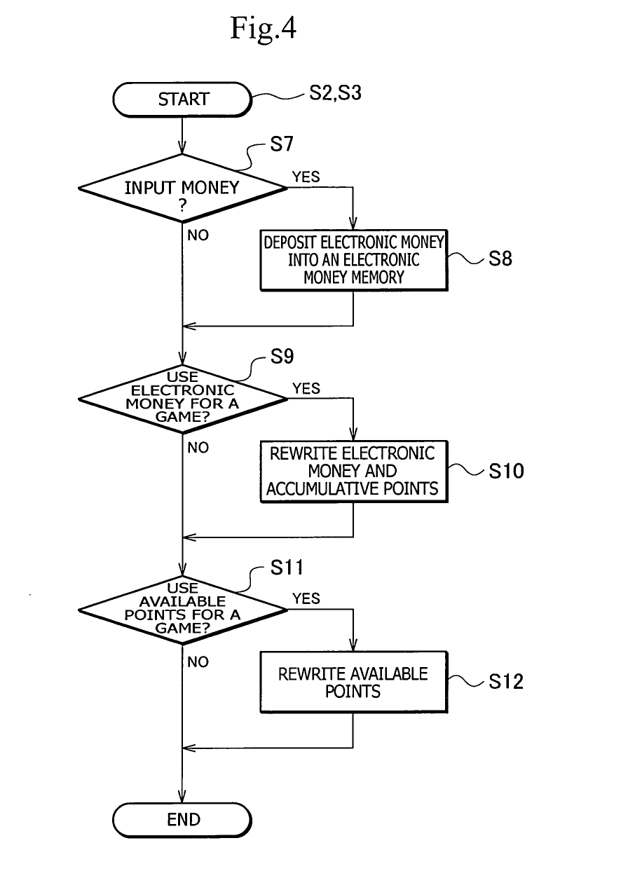

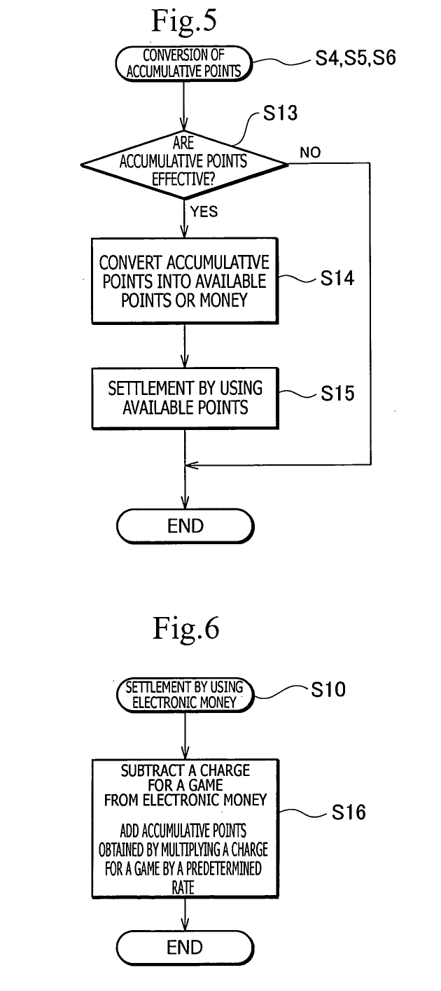

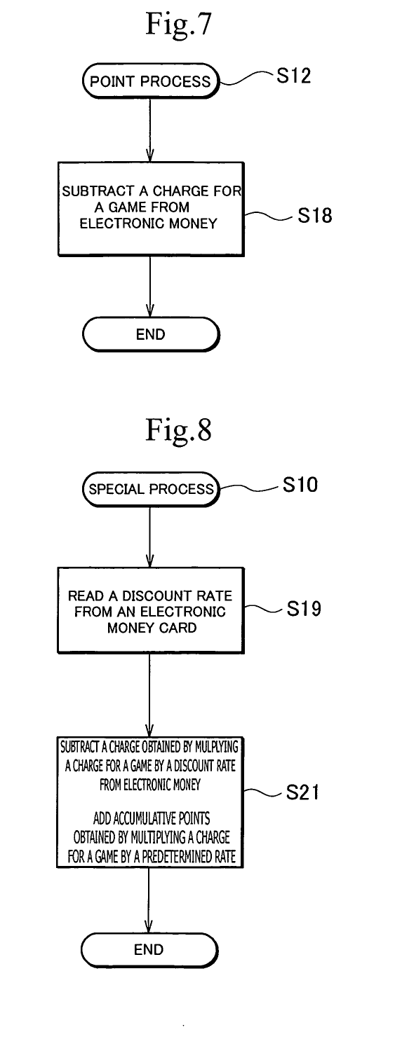

FIGS. 3 to 7 are flow charts each showing a process according to the first embodiment, in which FIG. 3 shows a general process, FIG. 4 shows details of steps S2 and S3 of FIG. 3, FIG. 5 shows details of steps S4, S5, and S6 of FIG. 3, FIG. 6 shows details of step S10 of FIG. 4, and FIG. 7 shows details of step S12 of FIG. 4.

When a user inserts an electronic money card 21 into the deposit/refund machine 15, the general process of FIG. 3 starts at step S1.

In step S1, the electronic money card 21 is formatted, and the general process of FIG. 3 proceeds to step S2.

In step S2, the user inputs money by, for example, inserting cash, a cash card, a credit card into the deposit/refund machine 15 to deposit electronic money into the electronic money card 21. This completes step S2, and the general process of FIG. 3 proceeds to step S3.

In step S3, the user brings the electronic money card 21 into the read/write field of the read/write part 17 of any one of the game machines 7 and 9 . . . that the user selects so as to face the communication part of the electronic money card 21 to the read/write part 17. Thereafter, when the user operates the deposit/refund machine 15 after making settlement for a game or games at the selected game machine, the general process proceeds to step S4.

In step S4, the deposit/refund machine 15 determines whether or not it conducts a conversion of the accumulative points stored in the accumulative point memory 29 of the electronic money card 21 into the available points according to user's operation. If the conversion is conducted, the general process of FIG. 3 proceeds to step S5. If the conversion is not conducted, the general process of FIG. 3 proceeds to step S6.

In step S5, the deposit/refund machine 15 converts the accumulative points into the available points. This completes step S5, and the general process of FIG. 3 returns to step S3 if the user plays a game or games again.

In step S6, the deposit/refund machine 15 refunds money to the user on the basis of the accumulative points. This completes step S6, and the general process of FIG. 3 returns to step S3 if the user plays a game or games again.

The processes of steps S2 and S3 will be explained with reference to the flow chart of FIG. 4 in detail.

In step S7 of FIG. 4, the deposit/refund machine 15 determines whether or not money is input into the deposit/refund machine 15. If the money is input, the deposit/refund machine 15 determines to make a request for a deposit of electronic money, and the process of FIG. 4 proceeds to step S8. If the money is not input, the deposit/refund machine 15 determines to not make a request for a deposit of electronic money, and the process of FIG. 4 proceeds to step S9.

In step S8, the deposit/refund machine 15 deposits electronic money corresponding to an amount of the input money into the electronic money memory 27 of the electronic money card 21. At the same time, the deposit/refund machine 15 stores a membership number of the user into the membership number memory 25. This completes step S8, and the process of FIG. 4 proceeds to step S9.

In step S9, the selected game machine determines whether or not the user selects use of electronic money for a game at the read/write part 17. If used, the process of FIG. 4 proceeds to step S10. If not used, the process of FIG. 4 proceeds to step S11.

In step S10, the electronic money stored in the electronic money card 21 are read from the electronic money memory 27 by the read/write part 17. When the user drops from the game machine, a balance obtained by subtracting a total amount of charges for all the games at the selected game machine from the read electronic money is input to the read/write part 17. The read/write part 17 rewrites the electronic money stored in the electronic money memory 27 of the electronic money card 21 brought into the read/write field by the balance after the subtraction. At the same time, accumulative points according to the amount of the charges is written or rewritten into the accumulative point memory 29.

In step S11, the selected game machine determines whether or not the user selects use of available points for a game at the read/write part 17. If used, the process of FIG. 4 proceeds to step S12. If not used, the process is terminated. Thereafter, if the user plays a game or games again, the general process returns to step S3 of FIG. 3.

In step S12, the available points stored in the electronic money card 21 are read from the point memory 31 by the read/write part 17. When the user drops from the game machine, a balance obtained by subtracting a total amount of charges for all the games from the read available points is input to the read/write part 17. The read/write part 17 rewrites the available points stored in the point memory 31 of the electronic money card 21 brought into the read/write field by the balance after the subtraction.

Steps S4 to S6 will be explained with the flow chart of FIG. 5 in detail.

In step S13, the deposit/refund machine 15 determines whether or not the accumulative points stored in the accumulative point memory 29 of the electronic money card 21 are effective. If the accumulative points exceed to the threshold, the accumulative points are effective. This completes step S13, and the process proceeds to step S14. If the accumulative points do not exceed to the threshold, the accumulative points are not effective. This terminates the process.

In step S14, the effective accumulative points are selectively converted into the privilege. If the user selects the available points as the privilege, the deposit/refund machine 15 converts the effective accumulative points into the available points and rewrites the available points stored in the point memory 31 so as to add the converted available points. If the user selects money refund as the privilege, the deposit/refund machine 15 converts the effective accumulative points into the money at a predetermined realization rate to be refunded to the user.

In step S15, when the user brings the electronic money card 21 into the read field of the read/write part 17 of a game machine which the user selects again, the user can make settlement by spending the converted available point.

Step S10 in FIG. 4 will be explained with reference to the flow chart of FIG. 6.

In step S16, when the user drops from the selected game machine and brings the electronic money card 21 into the read/write field of the read/write part 17, the read/write part 17 rewrites the electronic money stored in the electronic money card 21 by the balance of the electronic money after the subtraction to conduct make the settlement. The accumulative points obtained by multiplying a charge for each game by a predetermined coefficient are accumulated into the accumulative point memory 29 of the electronic money card 21.

Step S12 of FIG. 7 will be explained with reference to the flow chart of FIG. 7.

In step S18, when the user drops from the selected game machine and brings the electronic money card 21 into the read/write field of the read/write part 17, the read/write part 17 rewrites the available points stored in the point memory 31 by the balance of the available points after subtraction. This completes to make settlement for the games using the available points instead the electronic money.

In this way, even if the electronic money stored in the electronic money memory 27 becomes zero, it can make the user continuously hold the electronic money card 21 which stores the accumulative points that are convertible into privileges in the accumulative point memory 29. This can lead users to actively come to the amusement arcade 1 again. As this result, it can provide services more suitable for users.

A second embodiment of the present invention will be explained.

FIG. 8 is a flow chart showing a detail of a step S10 of the settlement system using electronic money according to the second embodiment of the present invention. The flow chart of FIG. 8 is conducted instead of the flow chart of FIG. 6 of the first embodiment.

According to the second embodiment, the electronic money card 21 stores a constant discount rate into the electronic money memory 27. The user is allowed to make a discount on settlement using electronic money at the discount rate.

In step S19 of FIG. 8, the read/write part 17 reads the discount rate together with the electronic money and the like from the electronic money card 21.

In step S21, when the user drops from the game machine and brings the electronic money card 21 into the read/write field of the read/write part 17, the read/write part 17 rewrites the electronic money stored into the electronic money card 21 by a balance after subtracting a discount charge from the read electronic money, to conduct a settlement for the game. The discount charge is obtained by multiplying the discount rate by a charge for a game.

According to the second embodiment, effect similar to those in the first embodiment can be achieved. In addition, the discount rate for unpopular game machines may be set to be relatively high and that for popular game machines may be set to be relatively low or zero, so that the rate of operation of the unpopular game machines may improve.

The settlement system may be applied to purchase for services and goods.

The recording medium may be provided to a mobile communication terminal such as a cellular phone instead of the electronic money card.

What is claimed is:

1. A settlement system using electronic money for accessible objects, comprising:
a recording medium for electronic money information comprising, an electronic money memory storing the electronic money information, and an accumulative information memory storing accumulative information for granting a privilege, the accumulative information accumulated according to spending the electronic money; and
a controller converting the accumulative information into the privilege on the basis of a set requirement.

2. The system of claim 1, wherein:
the set requirement allows to convert the accumulative information when the accumulative information exceed a predetermined threshold.

3. The system of claim 1, wherein:
the accumulative information is accumulated at a predetermined rate against spent electronic money.

4. The system of claim 2, wherein:
the accumulative information is accumulated at a predetermined rate against spent electronic money.

5. The system of claim 3, wherein:
the predetermined rates of the accessible objects are set to be different from each other.

6. The system of claim 4, wherein:
the predetermined rates of the accessible objects are set to be different from each other.

7. The system of claim 1, wherein:
the recording medium enables to spend electronic money from the electronic money memory at a predetermined discount rate.

8. The system of claim 2, wherein:
the recording medium enables to spend electronic money from the electronic money memory at a predetermined discount rate.

9. The system of claim 3, wherein:
the recording medium enables to spend electronic money from the electronic money memory at a predetermined discount rate.

10. The system of claim 4, wherein:
the recording medium enables to spend electronic money from the electronic money memory at a predetermined discount rate.

11. The system of claim 5, wherein:
the recording medium enables to spend electronic money from the electronic money memory at a predetermined discount rate.

12. The system of claim 6, wherein:
the recording medium enables to spend electronic money from the electronic money memory at a predetermined discount rate.

13. A recording medium for electronic money information, comprising:
an electronic money memory storing the electronic money information;
an accumulative information memory storing accumulative information for granting a privilege, the accumulative information accumulated according to spending the electronic money.
